(19) United States
(12) Patent Application Publication
(10) Pub. No.: US 2015/0109166 A1
(43) Pub. Date: Apr. 23, 2015

(54) Radar Unit and Method for Operating a Radar Unit

(71) Applicant: Hella KGaA Hueck & Co., Lippstadt (DE)

(72) Inventor: Thomas Hesse, Paderborn (DE)

(21) Appl. No.: 14/513,681

(22) Filed: Oct. 14, 2014

(30) Foreign Application Priority Data
Oct. 18, 2013 (DE) 102013111517.9

(51) Int. Cl. G01S 13/02; G01S 7/02

(52) U.S. Cl. CPC G01S 13/02; G01S 7/02
USPC 342/195; 342/175; 342/385

(57) ABSTRACT

A radar unit and a method for operating a radar unit. The method for includes a step of determining a functionality of a receiving channel in a radar unit, wherein the radar unit is configured for transmitting and receiving a signal in a frequency band, and has a control means, a transmission path with a voltage controlled oscillator and an output unit for generating a transmission signal and a transmission antenna for emitting the transmission signal, and a receiving path with at least one receiving channel for receiving, processing and conveying a received signal, wherein the at least one receiving channel has at least one receiving antenna and at least one switchable amplifier, wherein the control means is connected to the transmission path and to the receiving path, and is configured to be able to control the transmission path and the receiving path, wherein the at least one switchable amplifier of the at least one receiving channel is disposed at the input of the receiving channel and is connected to the receiving antenna.

### CROSS REFERENCE

This application claims priority to German Application No. 10 2013 111517.9, filed Oct. 18, 2013, which is hereby incorporated by reference.

### TECHNICAL FIELD

The invention relates to a radar unit, and a method for operating a radar unit.

### BACKGROUND

A radar unit can emit electromagnetic waves bundled to form a primary signal or transmission signal, and receive the signals reflected by an object as received signals, and evaluate these signals according to manifold requirements and applications. For this, data can be acquired regarding the object, for example, the distance to an object, the relative movement between a transmitter of the radar unit and the object, and also the shape of the object. Radar units are used in air traffic control, as weather radar, for research purposes in astronomy, for tracking targets in air defense, for monitoring buildings, and in a motor vehicle for monitoring the vehicle environment, to name just a few examples. Radar units can be designed as mobile and stationary radar units.

The requirements for the radar units that can be used in the vehicle assistance system of the motor vehicle are manifold, in particular, the radar unit must be able to be integrated in the motor vehicle without difficulties. For this, sensors for the radar unit are preferably disposed in the region of the motor vehicle bumper, behind the respective bumper, for example. The monitoring of the vehicle environment requires of the radar unit that an object must be able to be detected at an early stage, by means of which a special requirement is defined for the range of the radar unit that is implemented. Furthermore, a satisfactory distinction of objects is necessary, resulting in a high demand on the distance resolution being required, in particular in close range. In order to obtain a sufficient range, the mean transmission output of the radar unit is an important parameter. The range and the distance resolution are analyzed from the received signals, which are recorded in a receiving path of the radar unit with at least one receiving channel. The strength, in particular the amplitudes of the signals returned from the object can fluctuate very strongly. For this reason, the receiving channel has an amplifier for amplifying the signals received by a receiving antenna, which, in general, can be switched between at least two amplification stages.

A radar unit is known from DE 10 2011 055 693 A1, having a transmission path and a receiving path, which is configured for detecting a channel malfunction of the receiving channel. For this, the outlet of the oscillator is connected to an input of the control means for the radar unit, and the control means is configured for detecting the channel malfunction.

### SUMMARY OF THE INVENTION

It is the objective of the invention to create an improved radar unit and a method for reliably operating the radar unit.

This is achieved by means of a radar unit having the features of Claim 1, and with a method having the steps according to Claim 7.

The radar unit is configured for transmitting and receiving a signal in a frequency band, and contains the following components: a control means, a transmission path having a voltage controlled oscillator and an output unit for generating a transmission signal and a transmission antenna for emitting the transmission signal, and a receiving path having at least one receiving channel for receiving, processing and conveying a received signal, wherein the at least one receiving channel has at least one receiving antenna and at least one switchable amplifier, wherein the control means is connected to the transmission path and to the receiving path, and is configured such that it can control the transmission path and the receiving path, wherein the at least one switchable amplifier of the at least one receiving channel is disposed at the input of the receiving channel, and is connected to the receiving antenna. For this, the amplifier is preferably connected directly to the receiving antenna. The amplifier can be a first amplification stage of the receiving channel, wherein downstream additional amplification stages can be provided. The amplifier is preferably configured to function in the 24 GHz range, and to amplify signals having a frequency in the range of 24 GHz. The switchable amplifier can be switched between two values (high amplification and low amplification), and is switched during operation in order to adjust the dynamics of the received signals. This is because the amplifier must be able to amplify, in an appropriate manner, signals of different strengths at any time. By this means, the switchable amplifier can amplify signals appropriately, depending on the signal at its input, thus, relatively weak signals with a higher amplification factor, and signals having a greater amplitude with a lower amplification factor. By this means, in particular, the detection, without overmodulation, of signals having a greater amplitude is enabled. Because the switchable amplifier is disposed directly at the input of the respective receiving path, the respective receiving channel can be excited with an activation sequence that has been formed in a targeted manner, and as a result, a modulation of the output signal can occur. The excitation of the at least one receiving channel is simplified thereby, and is more effective in comparison with known radar units. In operation, a transmission signal, a radar signal having a frequency in the range of 24 GHz, for example, can be emitted, and the signal reflected by an object in the environment of the vehicle can be received by the receiving antenna of the receiving path, and amplified and sampled. It is advantageous to monitor the switching capability of the amplifier, because the switching capability can become limited, for example, by a hardware defect, or can fail. This would lead to overmodulation of the amplifier when a signal is not detected, or to the signal not being amplified at all. On the whole, this would result in a deterioration of the distance measurement, for example. If a malfunction of the switching capability of the receiving channel is detected, this receiving channel can be brought to a fault condition, and as a result, a further, undefined operation is prevented. The switching capability of the amplifier can be monitored during the running operation by means of the switchable amplifier being disposed at the input of the receiving channel, and the detected switching capability can be used in general as additional information in the diagnosis of the functionality of the receiving channel,

The at least one switchable amplifier is a low noise switchable amplifier. A low noise amplifier is referred to as an LNA (LNA: Low Noise Amplifier).

Preferably the at least one switchable amplifier is disposed upstream of a mixer disposed in the receiving channel, and a band-pass filter. In this manner, the received signal can first be amplified, and is then fed into the mixer, or the band-pass filter, respectively. By this means, a modulation with a frequency of approximately 20 kHz of the received signal can be executed. This in turn enables an operation at a fixed oscillation frequency of approximately 24 GHz. The modulation can also occur thereby on received signals having an amplitude not equal to zero. This is advantageous because at the outlet of the receiving antenna of a receiving channel, even if no radar target is present in the sensor environment, or vehicle environment, respectively, the received signal is not equal to zero, due to reflections on the bumper of the vehicle, for example. The signal component, which is generated in the amplifier by its switching frequency, would then be not equal to zero, and would lie in the transmission frequency range of the band-pass filter. Thus, a measurement of the switching frequency in the received signals is enabled, which is not dependent on the vehicle environment or the sensor environment.

Preferably a high-frequency circuit is provided, in particular a monolithic microwave integrated circuit (MMIC), which is configured to execute the processing of the at least one received signal, and to activate the output unit of the transmission path.

The control means has, in particular, a digital signal processor (Digital Signal Processor: DSP) having at least one signal processor interface (Signal Processor Interface: SPI), wherein a second digital signal processor interface (SPI2) is provided, which is connected to at least one switchable amplifier at the input of the at least one receiving path, and is configured to be activated by the signal processor. The digital signal processor can be a computer. The switching frequency of the amplifier in the receiving channel can be controlled by means of the digital signal processor. A frequency can preferably be applied to the analog received signal thereby, in particular a frequency of 20 kHz. A power-on time and a power-off time can, in each case, amount to 25 μs thereby.

Furthermore, the band-pass filter can be disposed between the mixer and the digital signal processor in the at least one receiving channel in the radar unit, which is, in particular, connected to the analog/digital converter (ADC) of the digital signal processor (DSP). The analog received signal can be converted into a digital signal by means of the ADC, and can be further processed in the digital signal processor; by way of example, a Fourier transformation can be executed for the analysis of the digitalized received signal. After a Fourier analysis of this type, a spectrum, depicted in FIG. 6, can be obtained, having a single peak at a large distance to the ambient noise level, by means of which a robust diagnosis of the switching capability of the amplifier is enabled.

The method for operating a radar unit is configured, in particular, for determining a functionality of a receiving path having at least one receiving channel, which has received and processed a received signal, wherein a modulation of the received signal occurs by means of a switching sequence, which is applied to a switchable amplifier disposed at the input of the receiving channel. Preferably, the switching sequence exhibits a frequency of 20 kHz.

In the method, a Fourier transformation can be used on the received signal, in particular, a Fast Fourier transformation (FFT) can occur after detection of the received signal. By means of the Fourier transformation, the analog received signal at the receiving channels can be analyzed in an analogous manner. In particular, a quantitative spectrum of the time signal can be obtained, where this is not equal to zero.

In differing from another method by the applicant, the frequency of the oscillator (VCO frequency) is not changed in the method according to the invention, but rather, the work is carried out at a constant frequency for the oscillator, and only a switching sequence with a specific frequency is defined for the amplifier. The frequency for the oscillator is 24 GHz, for example.

### BRIEF DESCRIPTION OF THE DRAWINGS

Reference is now made more particularly to the drawings, which illustrate the best presently known mode of carrying out the invention and wherein similar reference charac-ters indicate the same parts throughout the views.

FIG. 1 is a radar unit from generation 2.0 by the applicant,

FIG. 2 is a structure of a radar unit from generation 3.0 and 3.5 according to the applicant,

FIG. 3 is a diagram of a switching sequence for the receiving amplifier,

FIG. 4 is a diagram of a switching sequence for the frequency of the voltage controlled oscillator (VCO) for a method for the diagnosis of a functionality of a receiving channel,

FIG. 5 is a time signal for a receiving channel with a fast switching of the amplifier,

FIG. 6 is a quantitative spectrum of the time signal from FIG. 5.

### DETAILED DESCRIPTION OF THE DRAWINGS

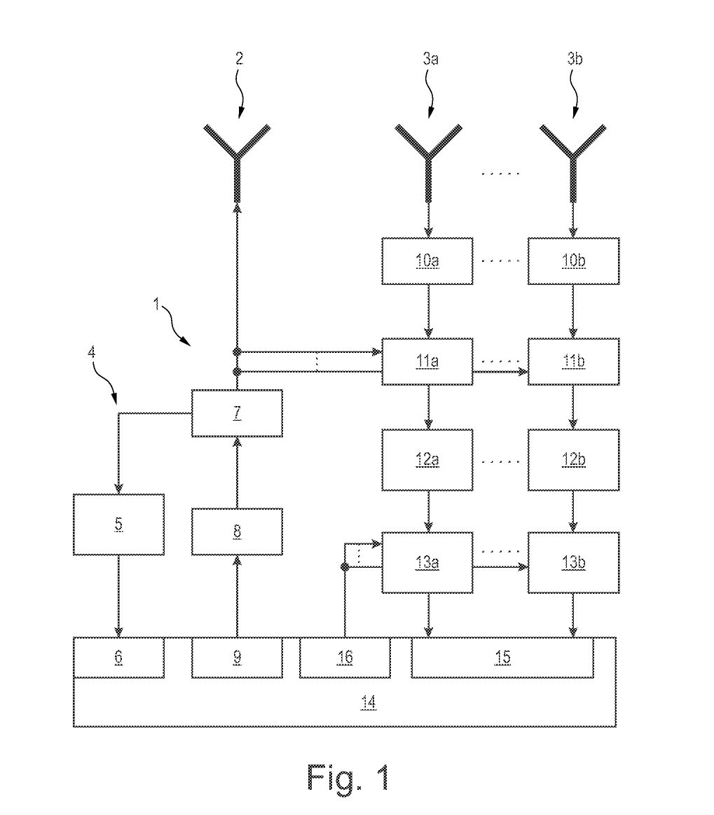

FIG. 1 shows a structure of a radar unit 1 from generation 2.0 by the applicant. The radar unit 1 comprises a transmission path 2 and at least one receiving path 3, having two receiving channels 3a and 3b. Moreover, a calibration path 4 is provided. The calibration path 4 has a frequency splitter 5, which is connected to a frequency counter 6.

The transmission path 2 comprises an oscillator 7, preferably a voltage controlled oscillator (VCO) 7, which functions at a frequency of 24 GHz. The transmission path 2 also has a digital/analog converter (ADC) 8, which is connected to a signal processor interface (SPI) 9. In the receiving path, an amplifier 10a, 10b, preferably a low-noise amplifier (LNA) 10a and 10b, a mixer 11a, 11b, and a band-pass filter 12a, 12b, are disposed, respectively, in each of the receiving channels 3a, 3b. A switchable amplifier 13a and 13b is disposed, in each case, downstream of the band-pass filter 12a, 12b.

The calibration path 4, the transmission path 2 and the receiving path 3 are connected to a digital signal processor (DSP) 14, wherein the calibration path 4 is connected to the frequency counter 6, the transmission path 2 is connected to the SPI 9, and the receiving path 3 is connected to an analog/digital converter (ADC) 15. The switchable amplifier 13 is connected to a GPIO-Pin 16 (General Purpose Input Output: GPIO) allocated to the DSP 14. The switchable amplifier 13 can be switched between two amplification stages. If the switchable amplifier 13 is in a first amplification stage, having a low amplification factor, received signals having a large amplitude can be detected, specifically without the occurrence of an overmodulation of the amplifier 13. If the switchable amplifier 13 is in the mode of a second amplification stage, having a large amplification factor, relatively weak signals can be detected. By this means, an increase in the dynamic range of the amplifier 13 is enabled. The switchable amplifier 13 can be switched periodically.

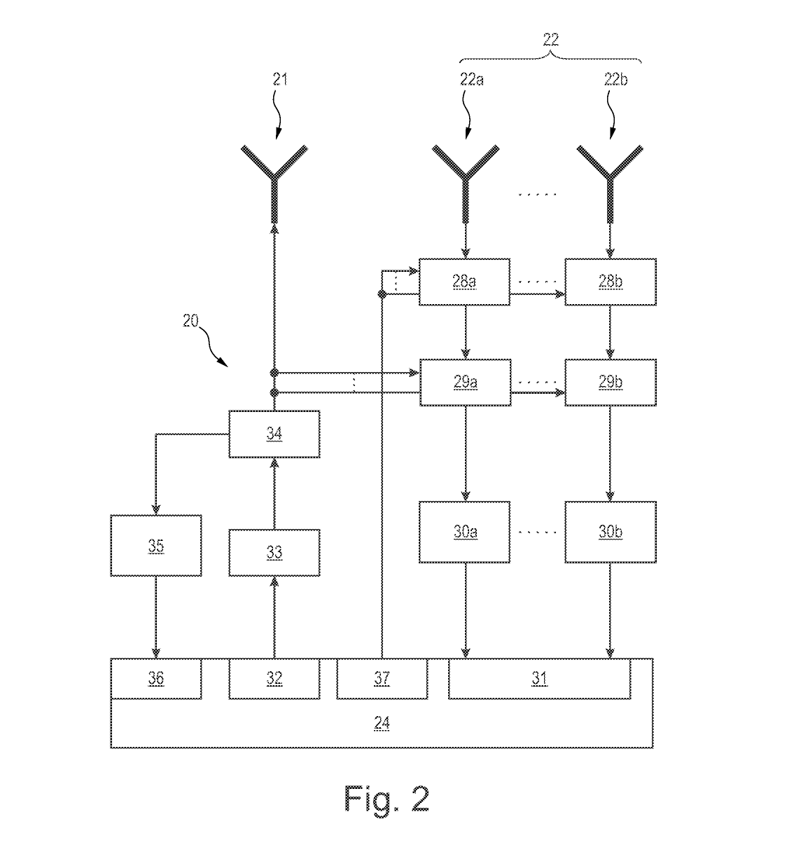

FIG. 2 shows a radar unit 20 from the generation 3.0 by the applicant, having a transmission path 21 for generating a transmission signal, and a receiving path 22 for recording a received signal. The receiving path 22 has a first receiving channel 22a and a second receiving channel 22b. The transmission path 21 and the receiving path 22 are connected to a digital signal processor (DSP) 24.

The receiving path 22 has, in each case, a switchable amplifier 28a, 28b, in particular a low noise amplifier (LNA) 28a, 28b, and a mixer 29a, 29b, in each receiving channel 22a and 22b. The respective mixer 29a, 29b is connected to a band-pass filter 30a, 30b, wherein the processed signals can be fed into the digital signal processor 24 after passing through the band-pass filter 30a and 30b. The measurement signal is converted thereby into a digital signal in an ADC (analog/digital converter) of the digital signal processor (DSP) 24. The transmission path 21 is activated via a digital/analog converter activator (DAC activator) 32 and a digital/analog converter (DAC) 33, wherein the signal from the DAC 33 is conveyed directly to a voltage controlled oscillator (VCO) 34. The VCO 34 exhibits a high-frequency oscillator, in particular a 24 GHz oscillator. Furthermore, a frequency splitter 35 connected to the VCO 34 is provided, which is connected to a frequency counter 36 in the DSP 24. A second signal processor interface (Serial Peripheral Interface: SPI) 37 is connected to the switchable low noise amplifier (LNA) 28a and 28b, and can control the switching of the low noise amplifiers 28a and 28b.

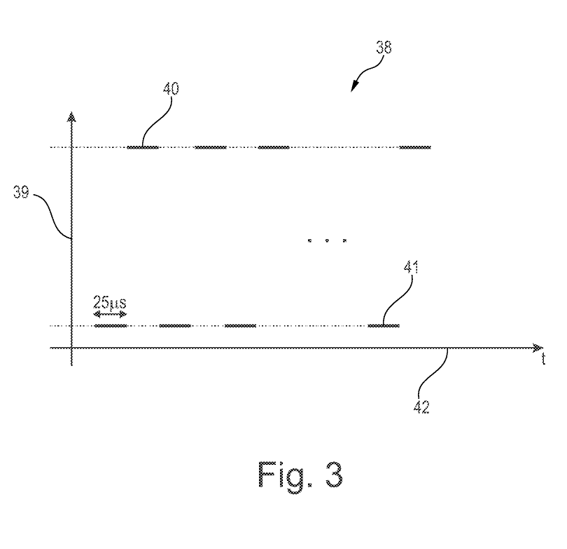

FIG. 3 shows a switching sequence 38. The settings of the LNAs 28a and 28b are plotted on the y-axis. The upper value 40 relates to a maximum amplification factor, and the lower value 41 relates to a minimum amplification factor. The duration of the switching sequence 41 is plotted on the x-axis 42, and the dwell time in a switching setting typically amounts to 25 μs. The targeted and fast toggling of the receiving amplifiers 28a and 28b results in an amplitude modulation of the received signal. By means of this procedure, a signal component having a frequency of 20 kHz can be applied to each of the analog received signals of the receiving channels 22a and 22b.

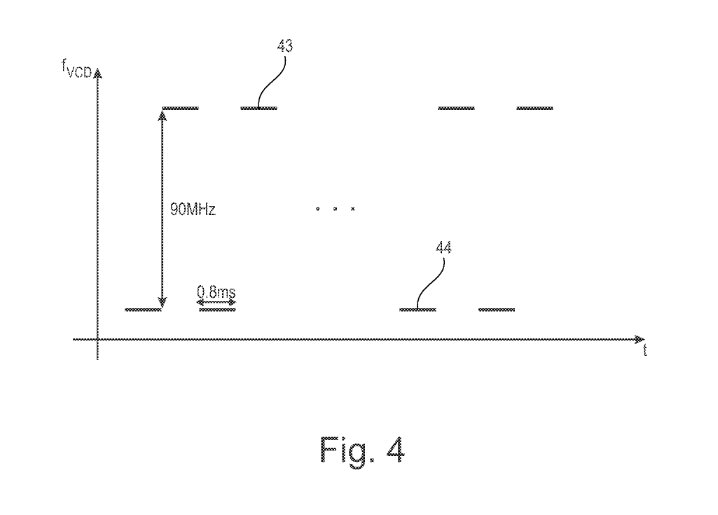

FIG. 4 shows a diagram depicting a first signal 43 and a second signal 44. The length of the respective signal 43, 44 is 0.8 ms. The frequency spacing of the first signal 43 from the second signal 44 is 90 MHz thereby. For this, a frequency counting process can be used by the frequency counter 36 for the calibration, which can provide for the setting of numerous individual digital/analog converter values, or frequencies, respectively, at 24 GHz, for example. Each individual frequency is kept constant thereby, over a time period of 0.8 ms, for example. An efficient counting of the frequency corresponding to that at the set digital/analog converter occurs in this time period.

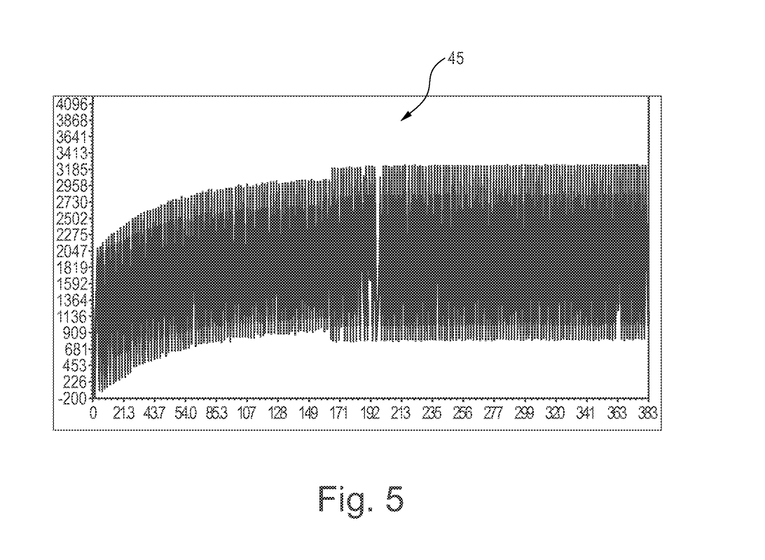

FIG. 5 shows an exemplary time signal 45 during the fast toggling of the corresponding LNAs 28a, 28b, with the switching sequence from FIG. 3 at a constant VCO frequency for a sensor environment without a radar target. The use of the switching sequence on the switching amplifier already disposed at the input of the receiving channels 22a, 22b leads to a modulation of the received signal with a frequency of 20 kHz. The switching sequence depicted in FIG. 3, having a frequency of 20 kHz is clearly visible in the time signal 45. The signal structure is simple, and contains no portions that would occur as a result of a switching of the oscillator frequency. Thus, a detection of the LNA switching sequence of 20 kHz at the time signal 45 can occur. The switching of the VCO frequency is no longer necessary due to the switchable amplifier 28a, 28b being disposed upstream of the band-pass filter 30a, 30b. The VCO frequency can be set at a constant value.

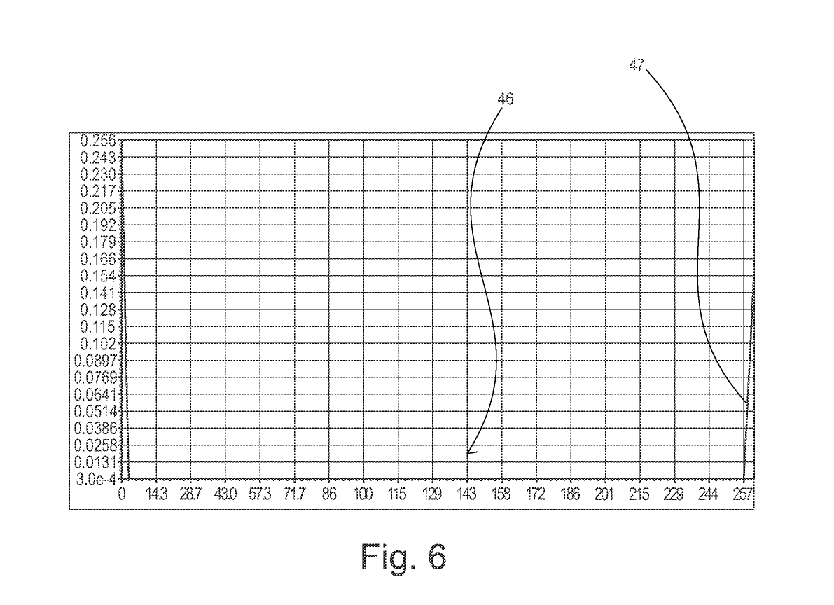

For clarification purposes, a quantitative spectrum of the time signal 45 is depicted in FIG. 6. The spectral component of the sub-signal 46, resulting from the switching of the LNAs 28a and 28b, is visible as a clear peak 47 in a frequency bin 256. This is a clear advantage over a typical quantitative spectrum, as is typical in another method by the applicant, and which would contain numerous peaks. In addition, the amplitude of the peak in the frequency bin 47 is clearly set apart from the background, and thus from the ambient noise level 46. By this means, a reliable detection of the peak 47 in the frequency range is possible. This leads to a robust diagnosis of the switching capability of the LNAs 28a and 28b.

### LIST OF REFERENCE SYMBOLS

1 radar unit
2 transmission path
3, 3a, 3b receiving path
4 calibration path
5 frequency splitter
6 frequency counter
7 voltage controlled oscillator
8 digital/analog converter (DAC)
9 signal processor interface
10a, 10b low noise amplifier: LNA, not switchable
11a, 11b mixer
12a, 12b band-pass filter
13a, 13b switchable amplifier
14 digital signal processor
15 analog/digital converter (ADC)
16 signal processor interface: general purpose pin
20 radar unit from generation 3.0, 3.5
21 transmission path
22 receiving path
22a, 22b receiving antenna
24 digital signal processor (DSP)
28a, 28b switchable low noise amplifier, LNA
29a, 29b mixer
30a, 30b band-pass filter
31 analog/digital converter, ADC
32 signal processor interface: SPI 1
33 digital/analog converter, DAC
34 voltage controlled oscillator, VCO
35 frequency splitter
36 frequency counter
37 signal processor interface: SPI 2
38 switching signal
39 y-axis in FIG. 3
40 maximum value
41 minimum value
42 x-axis in FIG. 3
43 first signal
44 second signal
45 time signal
46 sub-signal
47 peak of the sub-signal 46 in the frequency bin 256

1. A radar unit for transmitting and receiving a signal in a frequency band, comprising:
a control means;
a transmission path having a voltage controlled oscillator and an output unit for generating a transmission signal and a transmission antenna for emitting the transmission signal;
a receiving path having at least one receiving channel for receiving, processing and conveying a received signal, wherein the at least one receiving channel has at least one receiving antenna and at least one switchable amplifier;
wherein the control means is connected to the transmission path and to the receiving path, and is configured for controlling the transmission path and the receiving paths;
wherein the at least one switchable amplifier of the at least one receiving channel is disposed at the input of the receiving channel, and is connected to the receiving antenna.

2. The radar unit according to claim 1, wherein the at least one switchable amplifier is a low noise, switchable amplifier (LNA).

3. The radar unit according to claim 1, wherein the at least one switchable amplifier is disposed upstream of a mixer disposed in the receiving channel and upstream of a band-pass filter.

4. The radar unit according to claim 1, wherein a high-frequency circuit, in particular a monolithic microwave integrated circuit (MMIC), is provided, which is configured for executing the processing of the at least one received signal, and for activating the output unit of the transmission path.

5. The radar unit according to claim 1, wherein the control means has a digital signal processor (DSP) having at least one signal processor interface (SPI), wherein a second digital interface (SPI2) is provided, which is connected to at least one switchable amplifier at the input of the at least one receiving path, and is configured to be activated by the digital signal processor.

6. The radar unit according to claim 3, wherein the band-pass filter is disposed between the mixer and the digital signal processor in the at least one receiving channel, and is connected, in particular, to an analog/digital converter of the digital signal processor (DSP).

7. A method for operating a radar unit for determining a functionality of a receiving path that has received and processed a received signal, having at least one receiving channel, wherein a modulation of the received signal by means of a switching sequence occurs at the input of the receiving channel.

8. The method according to claim 7, wherein the switching sequence is used on a switchable amplifier disposed at the input of the at least one receiving channel.

9. The method according to claim 8, wherein switching frequency exhibits a frequency of approx. 20 kHz, which lies in a transmission range of the band-pass filter.

10. The method according to claim 7, wherein a Fast Fourier transformation (FFT) occurs after detection of the received signal.
